(19) United States
(12) Patent Application Publication
(10) Pub. No.: US 2016/0321707 A1
(43) Pub. Date: Nov. 3, 2016

(54) CONTACT DATA ENGINE

(71) Applicants: Lizzabeth Brown, Johnston, RI (US); Vincent Brown, Johnston, RI (US)

(72) Inventors: Lizzabeth Brown, Johnston, RI (US); Vincent Brown, Johnston, RI (US)

(21) Appl. No.: 15/141,307

(22) Filed: Apr. 28, 2016

Related U.S. Application Data
(60) Provisional application No. 62/153,734, filed on Apr. 28, 2015.

(51) Int. Cl. G06Q 30/02; H04N 1/21

(52) U.S. Cl. CPC G06Q 30/0269; H04N 1/2175; H04N 2201/0081; H04N 2201/218

(57) ABSTRACT

A method of tracking performance metrics of contact data in a networked computer environment, the contact data including organizations, events, event counters, and cards, generally includes assigning points from a point pool to a plurality of events according to user desired importance of each event over a specified time frame; optionally, calculating a weighted score goal (G) based on the assigned points of an event related to the point pool; assigning a desired weekly event target (T) to each event, representing the desired number of weekly event occurrences; tracking event occurrences (A) within the specified time frame; optionally, calculating a weighted percentage score (S) of a weekly event target (T) in relation to the total point pool; and reporting the result of the event occurrences (A) versus event targets over the specified time frame.

### CROSS-REFERENCE TO RELATED APPLICATION

This patent document claims priority to earlier filed U.S. Provisional Patent Application No. 62/153,734 filed on Apr. 28, 2015 and is a continuation-in-part of U.S. patent application Ser. No. 14/712,984, filed on May 15, 2015 which is a continuation-in-part application of U.S. patent application Ser. No. 14/206,216, filed on Mar. 12, 2014, and claims priority to U.S. Provisional Patent Application No. 61/993,388, filed on May 15, 2014, U.S. Provisional Patent Application No. 62/052,789, filed on Sep. 19, 2014, U.S. Provisional Patent Application No. 61/779,794, filed Mar. 13, 2013, and U.S. Provisional Patent Application No. 61/870,262, filed Aug. 27, 2013, the entire contents of which are incorporated herein by reference.

### BACKGROUND OF THE INVENTION

1. Technical Field

The present patent document relates generally to contact data management and more particularly to a method and system to propagate and maintain relationship links for contact data throughout a network or businesses and people.

2. Background of the Related Art

Computer systems and databases optimized for contact management that operate in a private networked environment suffer from the disadvantage that the contact information is not easily shared. Furthermore, these prior art systems do not maintain the relationship link between the contacts, thus not fully utilizing the contact data.

As shown in FIG. 1, a somewhat schematic block diagram 100 from a prior art method of sharing contact data is shown, such as Microsoft Outlook and Exchange products and Lotus Notes. As people become established in a particular field they develop a network of people with whom they regularly do business. When/if they change their contact information due to change of job, residence or other reasons it is very difficult if not impossible to easily notify all those who might have their business card. Typically, their network information is tied to a proprietary system owned by the company for which they work and is not transferable to another system.

Social network-style solutions to contact management, such as LinkedIn and AngiesList.com, have the additional disadvantage of becoming cluttered with comments and ratings.

Additionally, when businesses are sold, it can be difficult for a business to transfer their contacts to new business ownership. Part of owning a business is having an exit strategy. When a business owner wants to end business activities, they often have a desire to get some value from the contact information they have accumulated. It is possible to sell a contact list as part of a business's assets, but there is a high degree of probability that the existing customers will not continue a business relationship with the new owner since a trusting business relationship does not exist.

### SUMMARY

In view of the above, there is a need in the prior art of a method and system to manage contact data that provides for more fluid sharing of contact data between businesses and individuals and maintains the relationship link between contacts. Additionally, when a business is sold, there is a need to transition existing business contacts to a new ownership in a way that will allow the business to retain its customers.

The present technology solves the problems of the prior art by providing a contact data management system and method that allows people who maintain a business card or business contact information to easily update, maintain and propagate that information when/if it changes. Also, the method and system described herein allows such people to easily propagate any changes to their network of trusted business relations. Because of the nature of the data storage, propagation of this information is made possible across multiple computer operating systems and software environments.

Further, the method and system includes a process for transitioning existing business contacts to new business ownership such that the relationship is maintained with a high level of trust and continuity.

In one embodiment, the subject technology is directed to a method for transitioning existing business contacts of a first business to a second business comprising a plurality of steps. The method includes designating the second business as a recipient of the existing business contacts, indicating a time period for a transition of the existing business contacts to become fully associated with the second business, and determining a start date, and initial and final portion of the time period. During the initial portion of the time period, a second business card of the second business is displayed with a first business card of the first business any time the first business card would normally be virtually displayed and the second business card is displayed relatively less prominently than the first business card. During the final portion of the time period the second business card is displayed with the first business card any time the first business card would normally be virtually displayed and the first business card is displayed relatively less prominently than the second business card. More prominently can mean relatively larger, highlighted, a different color, bold print, combinations thereof and the like.

In another embodiment, a middle portion of the time period is determined. During the middle portion of the time period the second business card is displayed with the first business card any time the first business card would normally be virtually displayed both business cards are displayed equally prominently.

In still another embodiment the subject technology includes a console in a network environment for performing a process. The counsel includes data storage, a processor, a display, input/output devices, hardwired logic, at least one card reader, and program memory. The processor is in communication with the display, the input/output devices, the data storage, the hardwired logic, one or more card readers, and the program memory to access data to execute the process. At least one card reader is configured to receive a business card and, upon depression of a function key, scan the business card with a resulting image displayed on the display. A database on the data storage is configured to store and retrieve card data extracted from a plurality of images resulting from scanning business cards in the at least one card reader. The console has a logic operative to cause the processor and memory to create, read, update and delete contact information in the data storage, and the user can classify the plurality of resulting images.

In one embodiment, the console can conduct the process of transitioning existing business contacts stored for a first business to a second business. The console can do this by entering a time for a transition to start and a time period for the transition to take place and determining a change point in the time period. The console can then instruct a Web server to provide a first business card associated with the first business in unison with a second business card of the second business on a Web site of the first business, displaying the first business card relatively larger and more prominently than the second business card before the change point. After the change point, and until the time period ends, the console can instruct the Web server to provide the first business card in unison with the second business card, displaying the second business card relatively larger and more prominently than the first business card.

In yet another embodiment, the console can perform the additional step of determining a middle period in the time period. During the middle period, the console can instruct the Web server to provide the first business card in unison with the second business card, showing both cards as an approximately similar in size.

### BRIEF DESCRIPTION OF THE DRAWINGS

These and other features, aspects, and advantages of the present invention will become better understood with reference to the following description, appended claims, and accompanying drawings as follows.

FIG. 1 is a prior art representation for a method of distributing contact information.

FIG. 2 is an illustration of contact data being propagated between users in accordance with the subject technology.

FIG. 3 is an illustration of an internal data structure of the contact data engine in accordance with the subject technology.

FIG. 4A is an illustration of a collection of cards illustrating tagging the cards in accordance with the subject technology.

FIG. 4B is an illustration of a screen for searching for a contact via tags in accordance with the subject technology.

FIG. 4C is an illustration of an internal data structure of relationship between contact data and tags in accordance with the subject technology.

FIG. 5 is an illustration of showing editing the contact information of a card in accordance with the subject technology.

FIG. 6 is an illustration showing a user claiming ownership of a card in accordance with the subject technology.

FIG. 7 is an illustration showing a user adding a card to their collection in accordance with the subject technology.

FIG. 8 is an illustration showing a user's collection of cards in accordance with the subject technology.

FIG. 9 is an illustration of a user sharing a card with another user in accordance with the subject technology.

FIG. 10 is an illustration showing a step of a user selecting cards to be shared in accordance with the subject technology.

FIG. 11 is an illustration showing a step of a user entering a recipient's email address to facilitate sharing of cards in accordance with the subject technology.

FIG. 12 is an illustration of a recipient logging into the system and seeing a notification that cards have been shared to them in accordance with the subject technology.

FIG. 13 is an illustration of a recipient viewing a screen to select whether to accept or decline a shared card in accordance with the subject technology.

FIG. 14 is an illustration showing a user adding a relationship to cards in their collection in accordance with the subject technology.

FIG. 15 is an illustration showing a user searching for cards in their collection and other searchable cards in accordance with the subject technology.

FIG. 16 is an illustration showing a screen where a user can manually create a new card and enter contact information in accordance with the subject technology.

FIG. 17 is an illustration showing a screen where a user can create a group in accordance with the subject technology.

FIG. 18 is an illustration showing a screen where a user can enter a name for the group in accordance with the subject technology.

FIG. 19 is an illustration showing a screen where a user may add cards to a group in accordance with the subject technology.

FIG. 20 is an illustration showing a screen where a user may view only cards in a particular group in accordance with the subject technology.

FIG. 21 is an illustration showing a screen where a user may create a card for a person that does not have an account in the system in accordance with the subject technology.

FIG. 22 is an illustration showing a screen where a user my send an invitation to a person that does not have an account in the system in accordance with the subject technology.

FIG. 23 is an illustration showing a menu bar where a user may manage their group affiliations in accordance with the subject technology.

FIG. 24 is an illustration of a data structure illustrating group types in accordance with the subject technology.

FIG. 25 is an illustration of the relationships between cards, organization cards, organizations, groups, group cards and group types within the system in accordance with the subject technology.

FIG. 26 is an illustration of a screen where a use may assign points from a point pool to events the user desires to track performance metrics for in accordance with the subject technology.

FIG. 27 is an illustration of a screen illustrating a report of performance metrics to the user in accordance with the subject technology.

FIG. 28 is an illustration of data flow and tracking of event occurrences to the system and subsequent reporting in accordance with the subject technology.

FIG. 29 is an illustration of the relationships between an event, event counter and a profile within the system in accordance with the subject technology.

FIG. 30 is a flow diagram of a process for transitioning existing business contacts to new business ownership in accordance with the subject technology.

FIG. 31 illustrates a console 3100 in accordance with the subject technology.

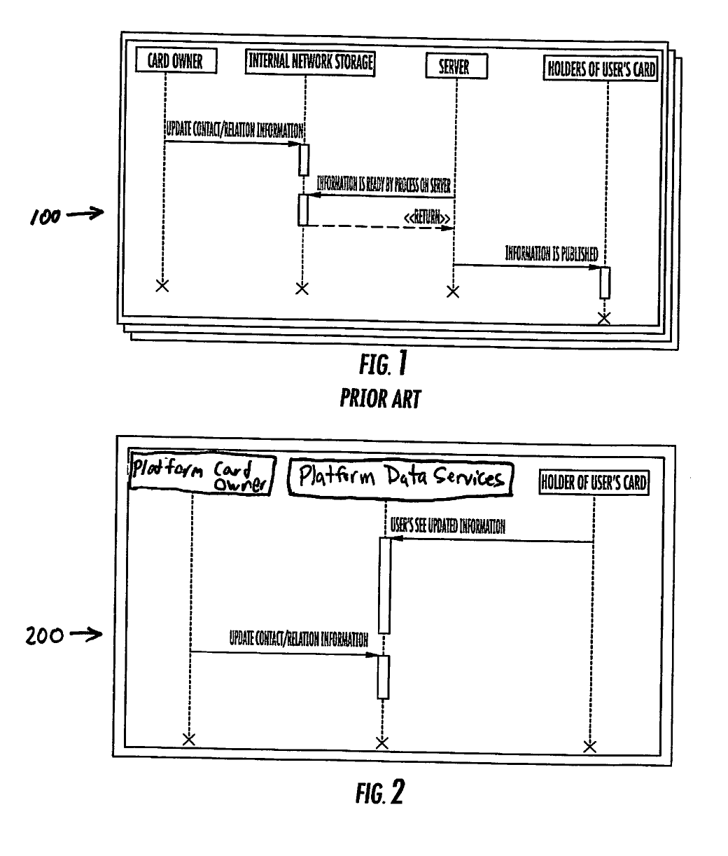

### DESCRIPTION OF THE PREFERRED EMBODIMENT

Referring now to FIG. 2, and as will be more fully described below, a schematic illustration 200 of a method and system of propagating contact data between users is shown. The method and system (Platform), is a cross-platform business card/contact information engine which allows users to easily update, maintain and share their business card data. The data repository is available via the Internet, mobile devices, and consoles such as described below. The following diagrams and charts describe the internal structure and behaviors of the system. Contact data is propagated through a Platform Data Service.

It should be understood that the present technology may be employed in any type of operating system. The present technology may be implemented in any type of software code using any language and can run on any type of computer hardware or networked computer hardware, including virtual machines. The computer hardware, virtual or physical, generally includes a processor, a program memory, and a data storage. The computer hardware may be networked, wired and wirelessly, to other computer hardware and accessible via other electronic devices, such as smartphones, PDA's and the like. The Platform may also be implemented by specialized hardware devices with processing capability such as a custom console for use exclusively to practice embodiments of the subject technology.

Further, the flow charts herein illustrate the structure or the logic of the present technology, possibly as hardwired logic in such customized consoles and/or embodied in computer program software for execution on a customized console, specialized computer, digital processor or microprocessor and/or completely hardwired. Those skilled in the art will appreciate that the flow charts illustrate the structures of the computer program code elements, including logic circuits on an integrated circuit, that function according to the present technology. As such, the present technology may be practiced by a machine component that renders the program code elements in a form that instructs a digital processing apparatus (e.g., computer) to perform a sequence of function step(s) corresponding to those shown in the flow charts.

Referring to FIG. 3, a schematic diagram 300 of an internal data structure in accordance with the subject technology is show. The contact data, or card, is the central data structure and has attributes that describe contact information. One and only one instance of a card exists in the system at any given time. References to cards are made discoverable to and shared with users through Platform Data Services. Cards may be edited by the Card Owner or, if Card Owner does not exist, the User that uploaded the card into the Platform Data Services. Cards have a number of different elements, including one or more addresses, phone numbers, and/or tags. The central data structure is preferably stored as in a relational database, where relations may be maintained between the cards and card owners and users of the system. No particular relational database system is required and the system may be implemented using any of a variety of open source or proprietary platforms known in the art, such as Oracle Database, IBM DB2, IBM Informix, MySQL, Microsoft SQL Server, PostgreSQL, Amazon AWS, and the like.

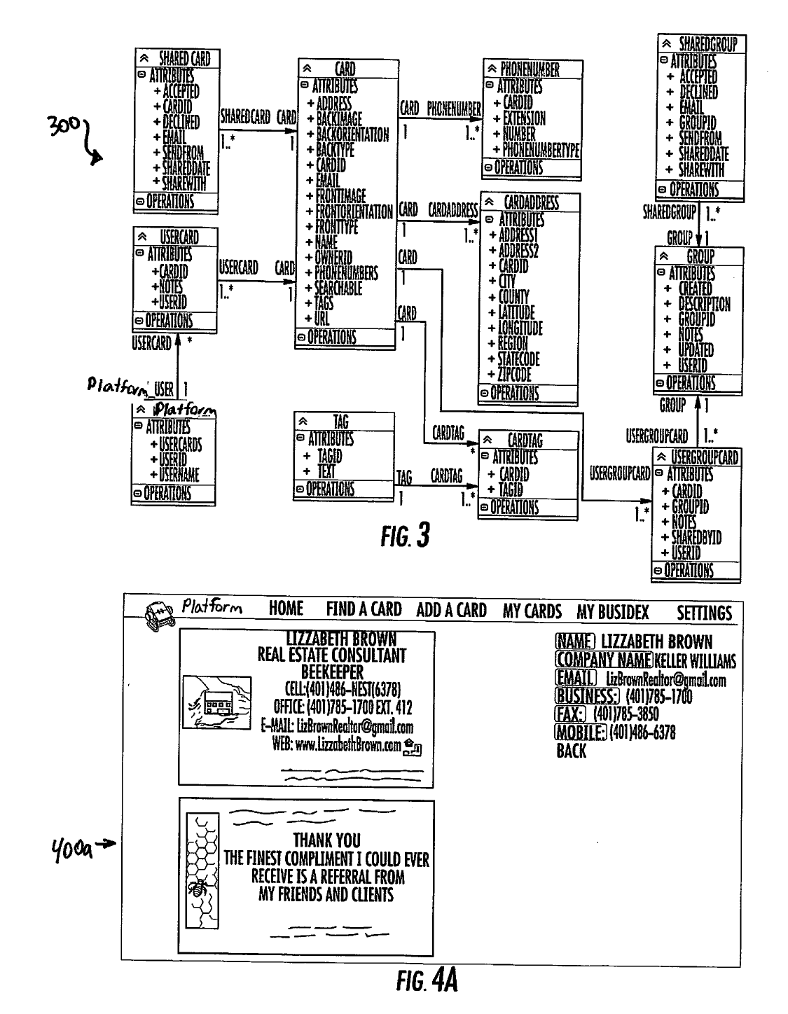

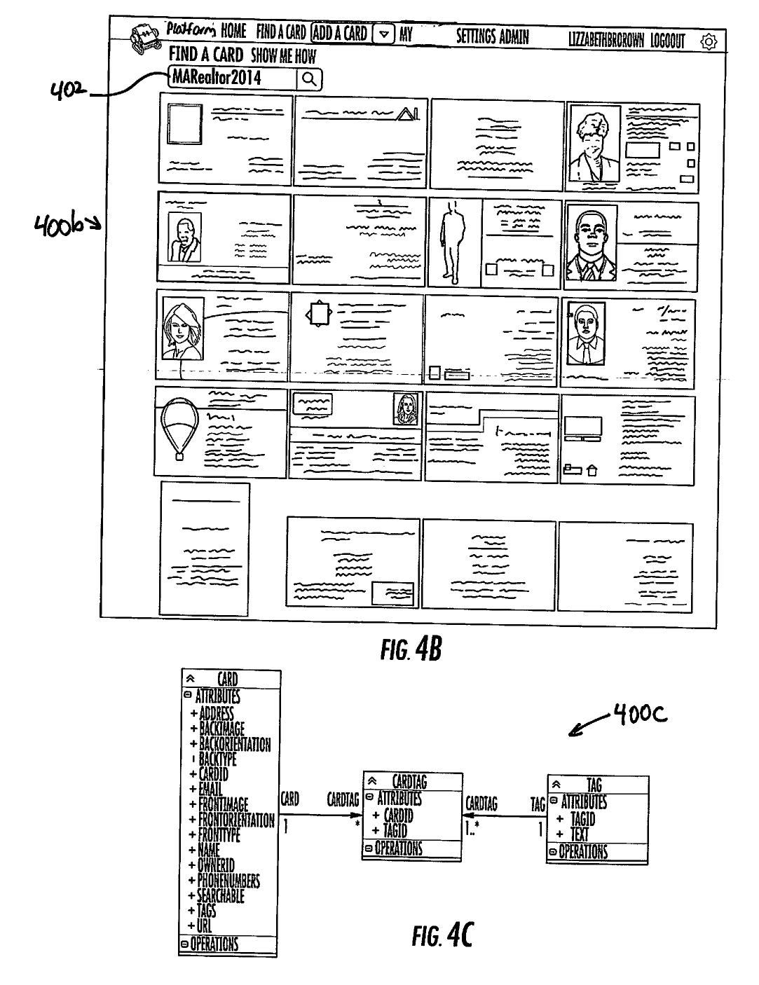

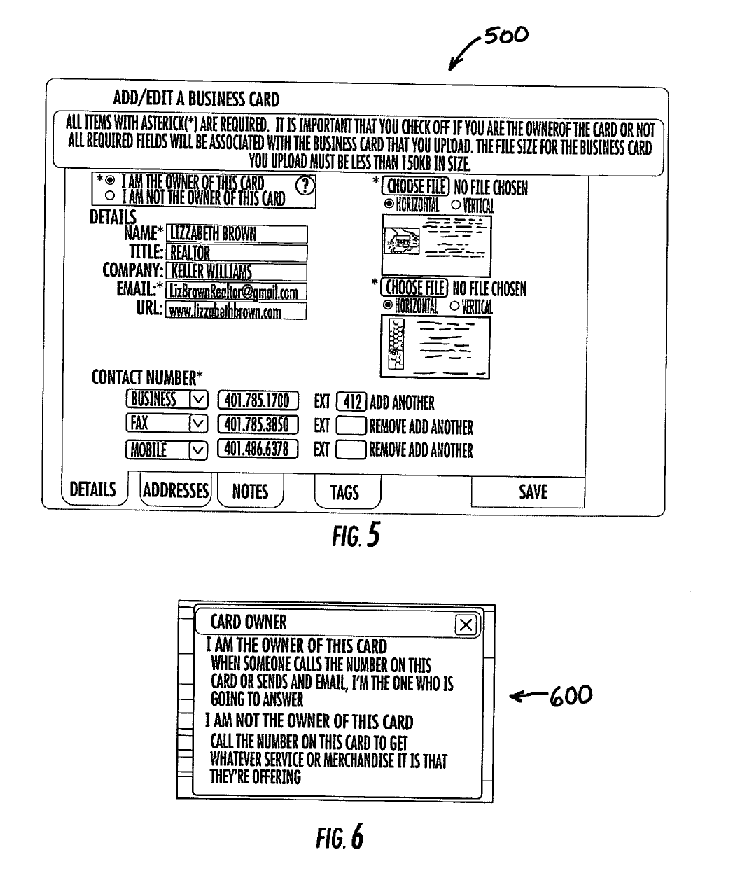

Referring to FIGS. 4A-C, FIGS. 4A and 4B illustrate collections 400a, 400b of cards. FIG. 4C illustrates another internal data structure 400c schematically. Each card may have one or more associated tags, used for searching, described further below, and organizing a user's cards. Tags are user-defined descriptive phrases that categorize cards. The same tag may be applied to one or more cards. Additionally, a second tag may be added as a subcategory of a first tag, resulting in a parent-child type relationship. For example, a tag for “Real Estate” may also include a second tag for “Real Estate Consultant.” Tags are one of the more powerful mechanisms in the Contact Data Engine, mainly because of the way they uniquely identify a Card in such a way as to be easily remembered. But they may also be used to identify a collection of Cards related by industry, proximity, personal relation or any other criteria.

One very specialized use of Tags is as a conference code. Business owners frequently attend trade shows, conferences and other such meetings with professionals in like industries. There is great value in maintaining these relationships after these events are over. Each Card Owner attending such an event would be given a unique Tag (some memorable word or phrase as it relates to the event) which can then be used as a quick lookup using the Contact Data Engine.

For example, as shown in FIG. 4B, forty-five members of the MA Realtors Association attend the annual Realtor's conference. Each member has their Card in the Platform. As part of the conference, each member is given a Tag 402 named “MARealtors2014”. From that point on, any time a member wants to contact someone who attended that conference, they simply search for that Tag using the Contact Data Engine without having to remember names or hunt through scraps of paper looking for phone numbers.

Another unique usage for Tags within the Platform is for creating a Membership Directory. The Membership Directory can have 1 . . . n levels of depth by combining Tags. For example, using the Tag “Dynex” someone can look up all employees of the Dynex company. Adding “Marketing” to the Tag search filters the list down to those employees working in the Marketing department. This filter can go as deep as is desired simply by adding Tag filters. This works by using a logical AND to combine Tag filters. In the Dynex example above, only cards with the Tags “Dynex” AND “Marketing” are shown.

Referring to FIG. 4C (also shown in FIG. 3), the data structure and relationship between the Tag and the Contact that makes this possible is a simple one-to-many relationship, where each tag is unique, thereby allowing for a Dictionary lookup at runtime.

Referring to FIGS. 5 and 6, screen shots 500, 600 in accordance with the subject technology are shown. Each card may be assigned a Card Owner. A Card Owner is defined as the person who is referenced by the contact information associated with the card i.e. Address, Phone Number, and/or Email. Once a card is owned, only the Card Owner may edit that particular card.

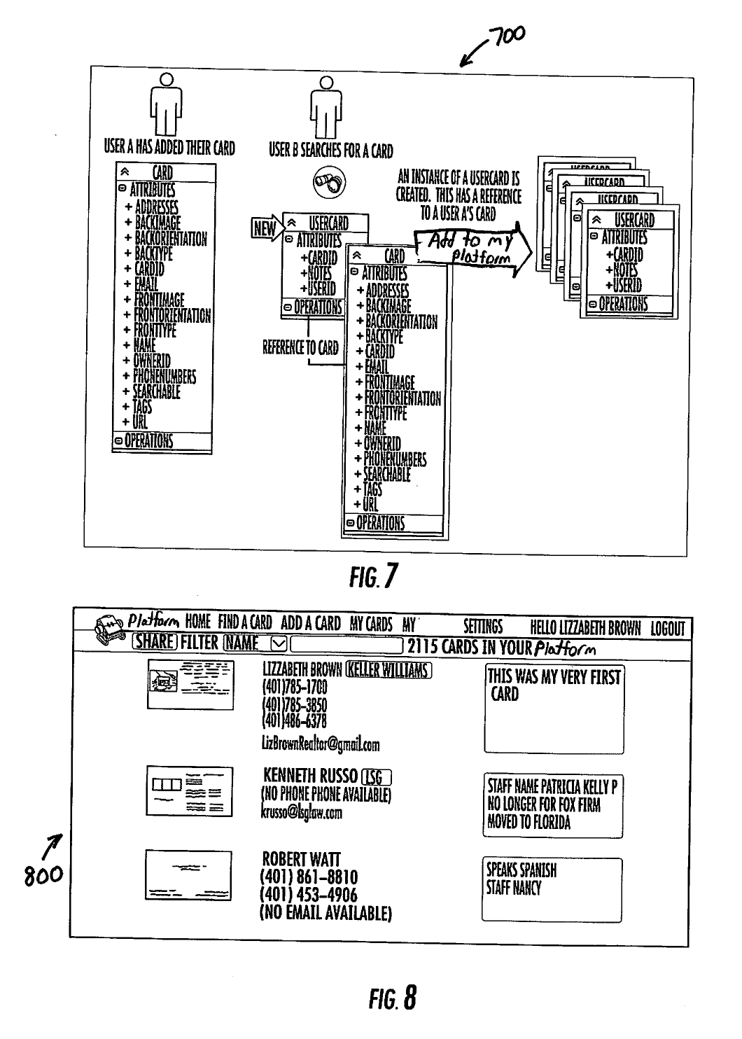

Referring to FIGS. 7 and 8, screen shots 700, 800 in accordance with the subject technology are shown. A user's cards are stored in a personal collection, called MyPlatform. Users can add cards to their personal collection, but may only edit Cards that they own or that they uploaded and are not owned. The collection contains references to cards, but not the actual card, which is unique to the system. When a card is updated, all references to that Card in any MyPlatform collections see the updates immediately. A user may add their own personal notes to a card, but these notes are not propagated through the system and remain private to the user that created the note.

Referring to FIG. 9, an environment 900 schematically illustrates how users may share cards to other users. When a card is shared, an instance of a shared card is created and transmitted to the recipient. The recipient may choose to accept or decline the card. If accepted, an instance of the card (with a reference to the original card) is created and stored in the recipient's MyPlatform collection.

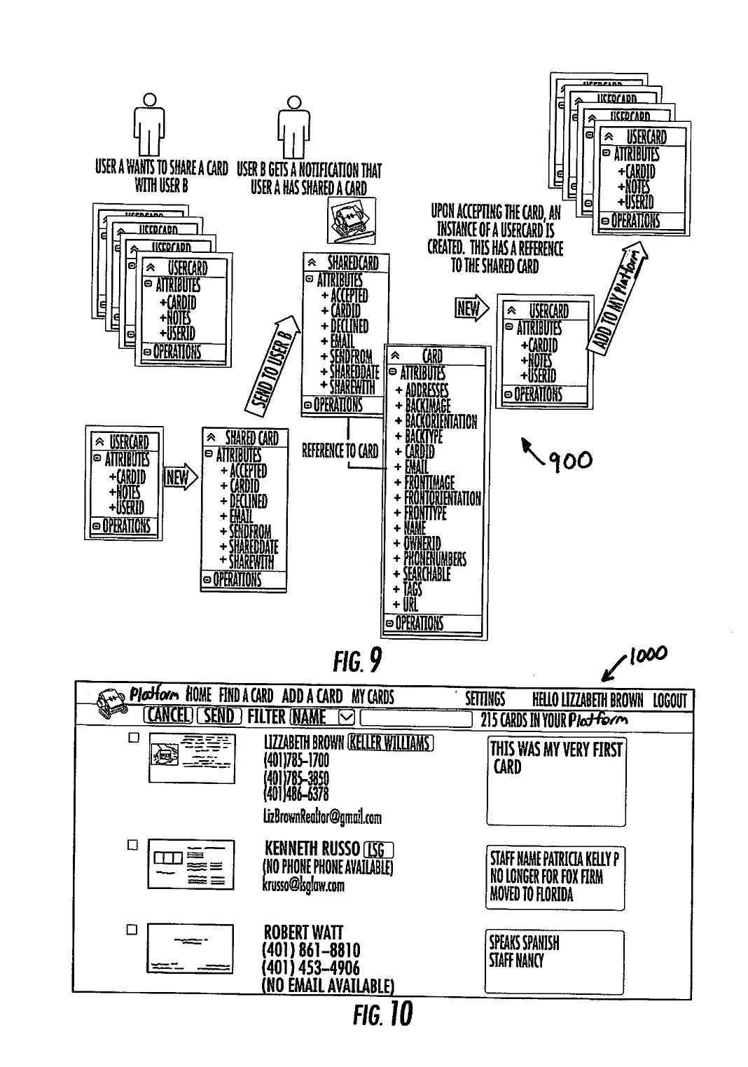

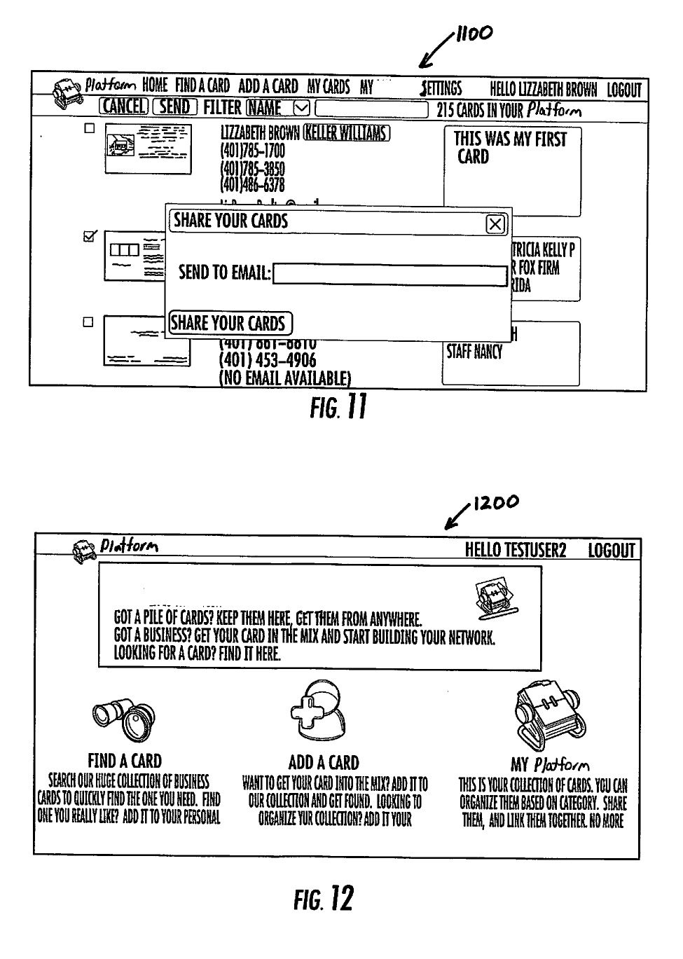

Referring to FIG. 10, a screen shot 1000 is shown, which is in accordance with the system and method providing such screen 1000 for a user to select one or more cards to share. The user, via a graphical interface, my select as many cards in their own collection to share as are available.

Referring to FIG. 11, a screen shot 1100 is shown, which is in accordance with the system and method for provides a user the ability to enter an email address of a person with whom to the share the selected cards from the step shown in FIG. 10.

Referring to FIG. 12, is another screen shot 1200 illustrating when the recipient logs into the system, where they receive a shared card notification. Cards are filtered from searches based on a Privacy flag, which allows a Card owner to control who can view and share their Card. There are three different Privacy Flags—Public, Semi-Public, and Private.

With the Privacy flag set to Public, anyone can find the user's card, and add it to their collection and share it. With this option a Card will be completely searchable by name, company, title, email, and any tag is have associated with the Card. Anyone with or without a Platform Account can find the Card in a search, and only those that do have a Platform Account can add the Card to their Platform Account.

With the Privacy Flag set to Semi-Public, a user's card can be found only by those with whom it has been shared, and anyone can share your card. During searches, the user's card will not be searchable by anyone except by those that have a Platform account with whom the card has been shared. If a Card is shared with someone that does not have a Platform account they will need to open an account to view the Card in their Platform page. Once a Card is shared, those with whom the Card has been shared have authorization to then share the Card with whomever they wish.

With the Privacy Flag set to Private, a Card can only be found by those with whom it has been shared, and only the Card owner can share the card. With this option a Card can only be shared by the Card owner. Even those that have your Card in their Platform collection cannot share it. The Card owner is the only person that can Share the Card with others.

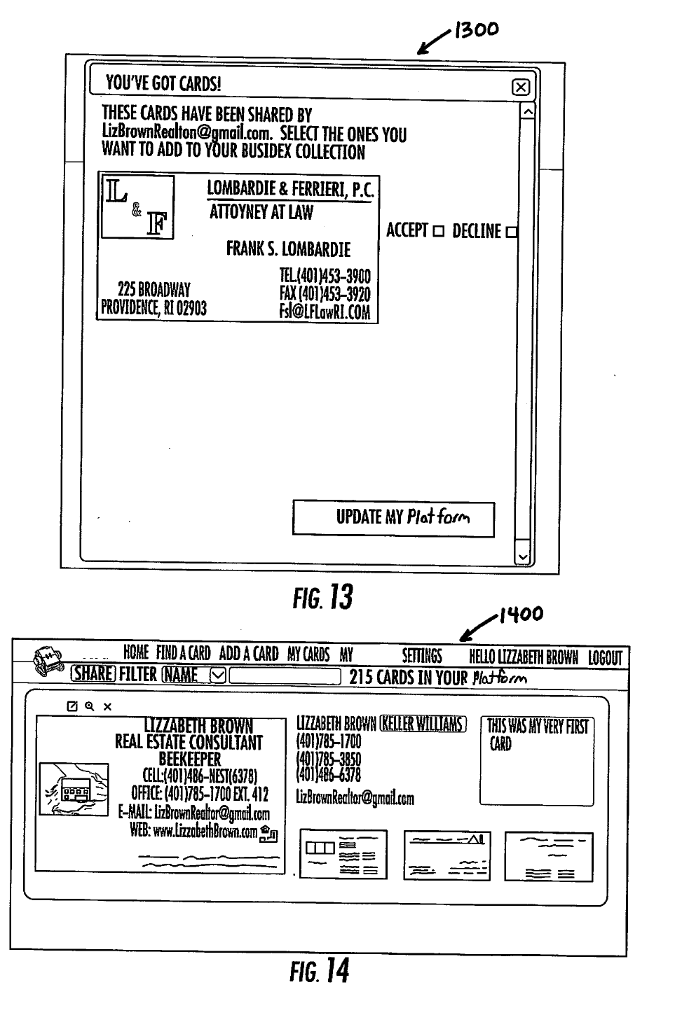

Referring to FIG. 13, a screen shot 1300 is shown wherein the recipient may accept or decline the shared cards. If accepted, the card will be added to the recipient's cards, i.e. MyPlatform collection.

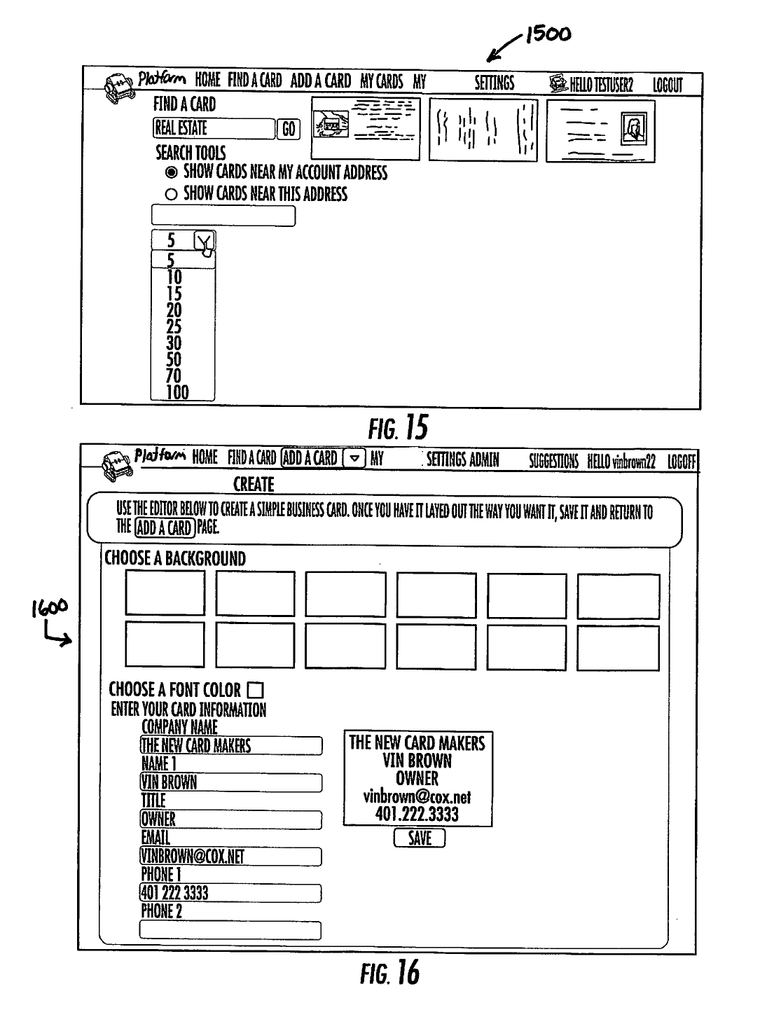

Referring to FIG. 14, a screen shot 1400 is shown wherein the user may create, update and delete a relationship for each card in their collection. Card Owners may select cards in their MyPlatform collection to be ‘related’ or associated with their own card. Related cards, which are shared, will show up in the card details for all those with whom the cards are shared. For example, User A is a Real Estate Agent. User A may choose to upload two loan officer's cards and a lawyer's card to their MyPlatform collection. User A marks those cards as Related to his own card. User A has a client (User B), and shares the related cards with User B. When User B views User A's card in their MyPlatform collection, the related cards will appear along with User A's card. The related cards only show in User B's MyPlatform collection, because although they are marked as related, they were only shared with this User B. When other clients view User A's card in their Platform collection, they do not see the related cards, since User A did not share those cards with them. The Platform Data Service recognizes when to show the list of related cards to a user by locating a matching record in Card Relation table

Referring to FIG. 15, a screen shot 1500 is shown wherein a user may search through their MyPlatform collection and all cards that are searchable. Cards are considered “searchable” if they have a Card Owner; otherwise they are not publicly visible. If a user is logged in, the scope of a Search includes all cards in their MyPlatform collection as well as all Searchable Cards. Search criteria may include tags, names, phone numbers, and/or company or employer name. Because geo-location is also an attribute of a Card, it is possible to limit a search to a distance radius or defined geographic area, such as a state, city, or metropolitan area.

Referring to FIG. 16, a screen shot 1600 is shown wherein the system and method provides for a user to manually create a card using an online editor. Using the online form, users can choose the card background color, font color and enter card attributes while getting immediate visual feedback as to what the card will look like. The system will save the HTML markup used to display the card and store it on the card record. Cards may also be imported using scanners or common file formats, such as CSV and other delimited formats. A user may also import third party contacts into their Platform from other sources, such as email service contact lists, like gMail, Yahoo mail, outlook contacts and the like, and may further send invitations to selected contacts from those lists.

Referring to FIGS. 17-22, various screen shots 1700, 1800, 1900, 2000, 2100, 2200, respectively, are shown wherein users can organize their cards into groups, or Busigroups. One card can be in zero or many Busigroups. A Busigroup can contain as many cards as the user wants. Busigroups may also be shared between users. The users in a group of shared cards may add notes to each card in the Busigroup. Each user's notes are only visible to the owner of the Busigroup, and not the other users. All members of the group receive notifications when new cards have been added to the group. Only the owner of the group may add and remove cards. The Busigroup owner may add notes to all the cards in the Busigroup, which are visible to all the group members.

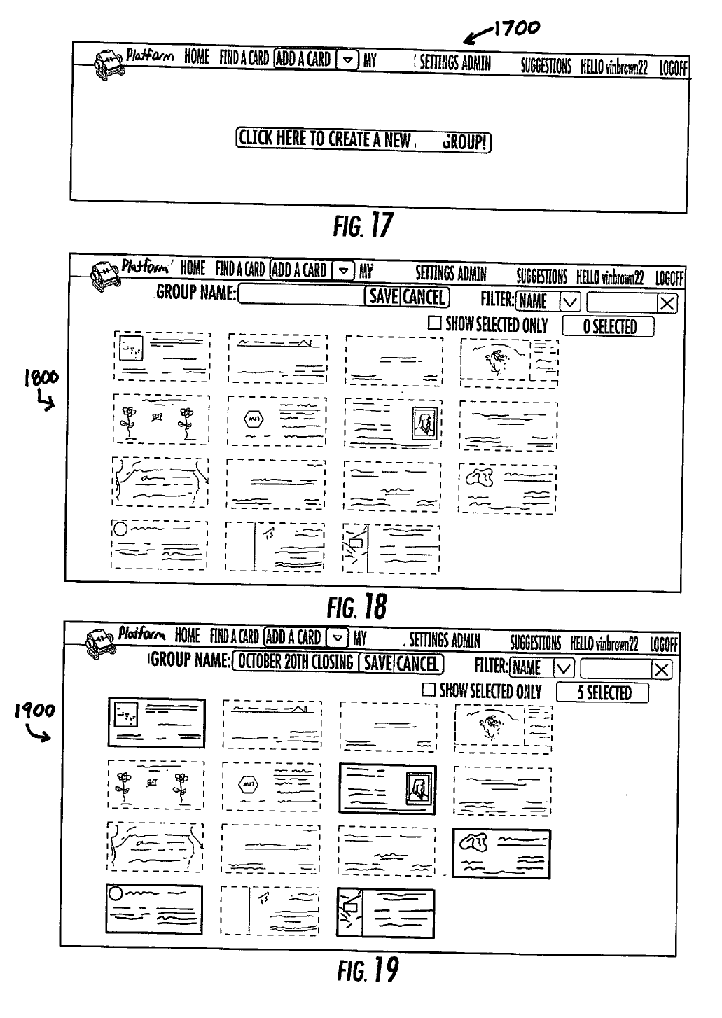

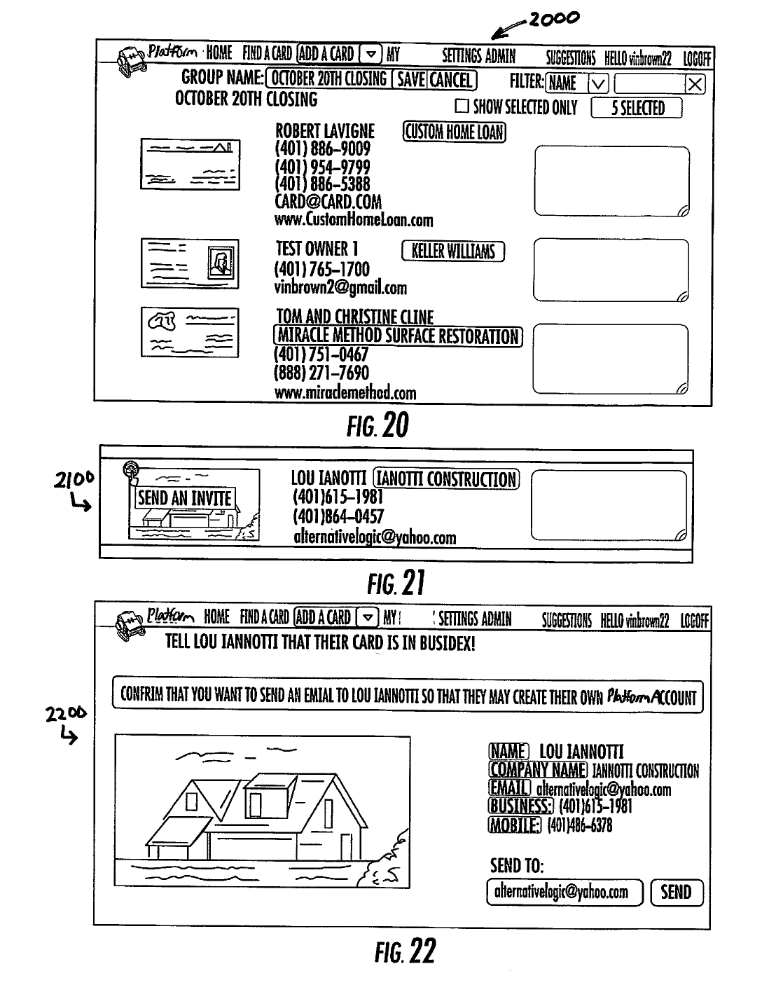

Referring in particular to FIGS. 17 and 18, a user first creates the group by selecting an option to create a group and then assigning the group a name. The user then adds cards to the group via a graphical user interface, as shown in FIG. 19.

Referring to FIG. 20, the user then may view the group that they just created. The user may then share the group with other users by sending an invitation as described above with individual cards.

A user can organize Cards into specialized groups called Organizations. A user whose card is part of an Organization is said to have a Membership in that Organization. Therefore, these are presented to the user as Memberships. Users can belong to zero or many Organizations. Users can remove themselves from an Organization at any time. Users can Share a Card with the Administrator. All users who's card is contained in an Organization can view all the cards in the Organization. Cards within an Organization can be put into Groups. Users can only view the Groups to which they belong within an Organization. Members receive a notification when new cards have been added to the Organization. Notes are visible to everyone in the Organization. The Organization has a dedicated Home page which contains metadata about the Organization, including, Name, Logo, Url, Email, Contact Number, Social Media contact info (Twitter, Facebook, etc.) and Notes/Messages for members.

Users who do not own a Card can be added to an Organization as Guests.

Only the creator (Administrator) of the Organization can add or remove cards. Only the Administrator can add notes to the cards in the Organization. Only the Administrator can create/edit or delete Groups within the Organization. The Administrator of an Organization has a MyPlatform collection which is visible to all Members of the Organization, unlike the usual MyPlatform collection which is private to the user. This specialized collection is called the Organization Referral List. Only the Organization Administrator can accept or remove Cards in the Referral list. Only the Organization Administrator can update the information on the Home page.

Referring, to FIG. 23, Memberships are presented to a User (non-administrator) as a menu bar option in screen shot 2300, where the User may view organizations that they are a member of.

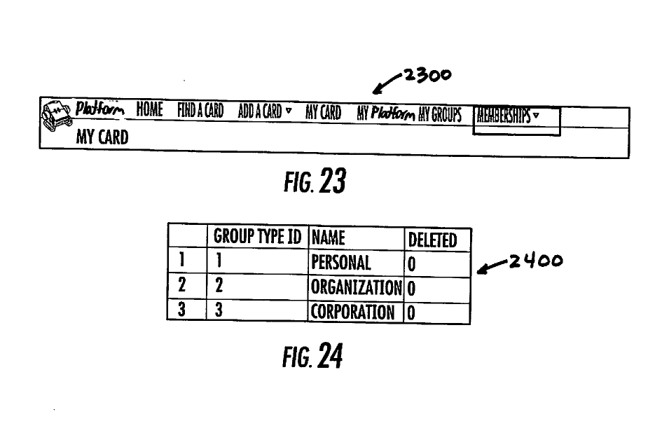

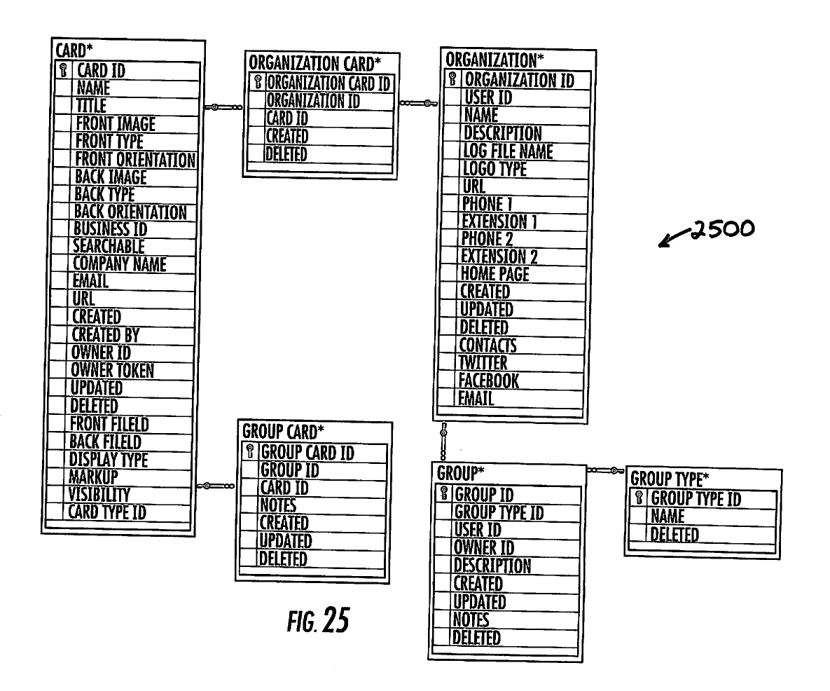

Referring to FIGS. 24 and 25, each membership has a type as illustrated in screen shot 2400. These types are categorized in a Group Types table, which identifies three types of Groups a User may be a member as may be represented by logical grouping chart 2500. Specifically, these Group Types may be personal, Organization and Corporation. Personal groups are User defined groups that have no official organization. Organizations are more formal and may be used for non-profits, professional associations and other collective entities run by their members. The Corporation group types are for business entities. Whatever group type the Organization is, an organization has a relational structure that intersects with groups and cards. As noted earlier an Organization may have an Organization Card. A card may belong to many organizations or Groups. Individual Cards may also belong to many Groups or Organizations.

Enterprises are identical to Organizations in every way, with the distinction that where each Card within an Organization is owned individually by each Card Owner, Cards within an Enterprise are owned by one person/entity and managed by an Enterprise manager.

Referring back to FIGS. 21 and 22, a user may share a card with another person that does not have an account with Platform Data Services. Users can invite business owners that do not have an account by adding a card of the business owner to the Platform collection and then sending an invitation via email to the email address supplied for that card.

A business starts with a pool of points, much in the same way as when building a video game character. Just like the character, a business has attributes to which the user can assign points from the base pool. But you only have that pool to draw from. The user cannot assign all the points to all the attributes since they have a limited amount of resources and it would be impossible to put 100% of those resources on every aspect of the business.

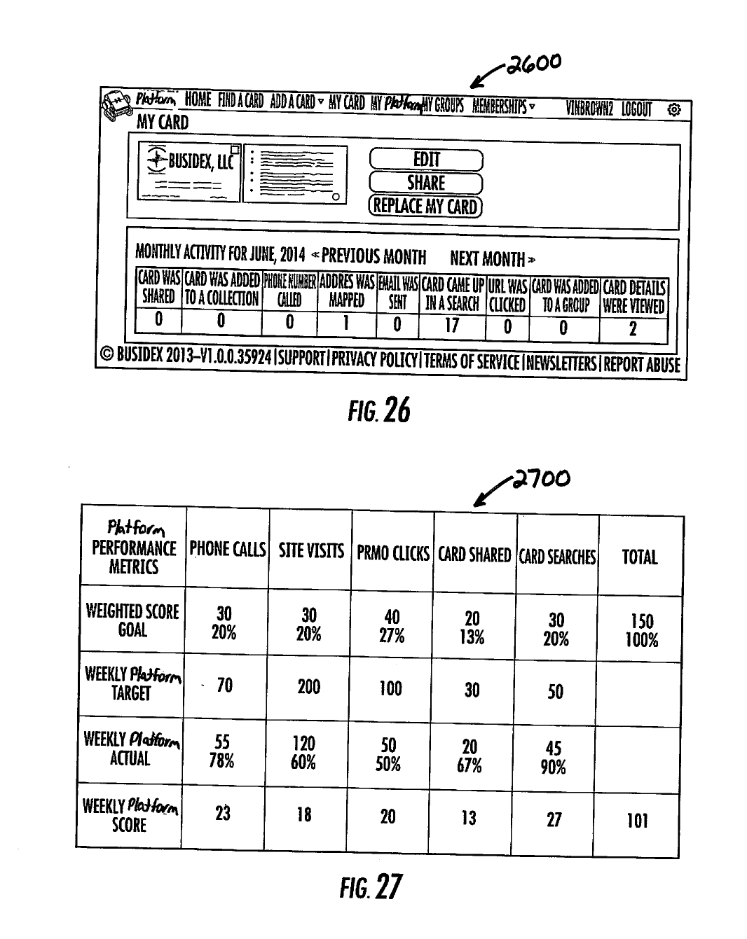

Referring to FIGS. 26 and 27, screen shots 2600, 2700 are shown, respectively. The first step is to define what attributes are most important to growing your business. The things in this list should not be what actually makes you money, but rather the things that *lead* to making you money. So it is not important to count how many orders were received in a given period, but rather what things were actively done that led to those orders. That might be number of phone calls, number of visits to your website, number of appointments set up and things of that nature. In the fictitious example illustrated in FIGS. 26 and 27, we see that Al's Pizza House has filled in the value points in the various metric categories (Platform Performance Metrics) which it thinks/believes will drive revenue. According to this chart, Al's Pizza House believes that the most important area that needs to be focused on is promotions and getting people to use Platform to access them.

Once this profile is set up, the Platform data service tracks user actions in an anonymous fashion using aggregated KPI (Key Performance Indicator) counters that cannot be tied back to an individual. The following data points are used in the calculation of a Platform Score:
a. Total Point Pool: An arbitrary number significantly large to allow for meaningful representation of individual performance metrics.
b. Weighted Score Goal (WSG): This is the value score (G) of a KPI as determined by the card owner in relation to a fixed base pool of points.
c. Weekly Platform Target (WBT): This is the target number of times as determined by the card owner that a KPI event (T) occurs in the Platform system.
d. Weekly Platform Actual (WBA): The actual number of times a KPI event (A) occurs in the Platform system.
e. Weekly Platform Score (WBS): The weighted percentage score (S) of an individual KPI in relation to the total point pool, defined as S=Σ(G*(A/T)).

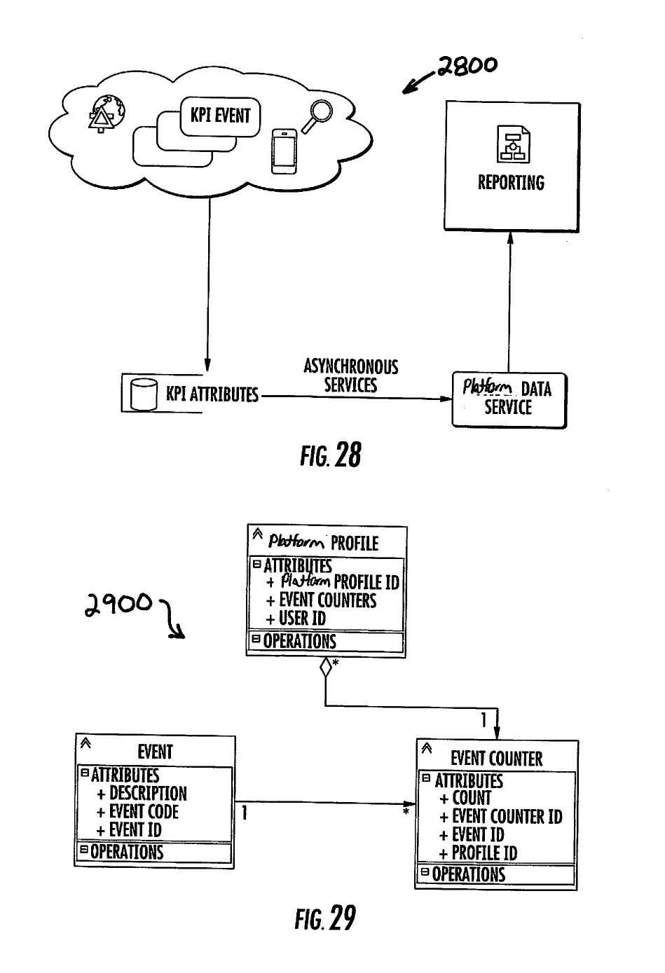

Referring to FIGS. 28 and 29, an environment 2800 in which the Platform and subject technology can be used is shown and a schematic representation 2900 of data flow in the environment are shown, respectively. Using events (interactions) within the Platform, the system keeps counters and aggregates of system-defined and user-defined events. The flow of data within the system generally starts with an event. If the event meets certain attributes is it tracked and logged in the Platform, which subsequently reports the results of these events to the user. An event has a data structure that defines the events qualities, and an event counter. The event counter is associated with each user that attends the event.

Each card owner has at least one Platform Profile associated with them. A Platform Profile consists of a collection of Event Counters. Events in the Platform are predefined user interactions which represent a user making an active choice to engage in discourse (financial or informational) with the card owner. User-defined events may also be created, but are given a less weighted value since there is no way to validate them within the system

Platform Performance Metrics are significant because they represent validated data within the system. In contrast to non-validated event data—for example, star ratings and reviews—validated metrics have intrinsic positive value to the card owner because they show proof of a user action with the intent to do business or inquire about doing business with the card owner, and represent an action with the opportunity for reaction by the card owner.

By using the card data (phone numbers, email, website url, etc.) the Platform Data Service can gather these events and generate Platform Performance Metrics in near-real-time.

Therefore, it can be seen the method and system described herein provides a unique approach to sharing and propagating contact information among users that is easy to update and maintain.

The flow charts herein illustrate a structure or logic of the present technology, possibly as embodied in computer program software for execution on a computer, digital processor or microprocessor and/or partially or completely hardwired into a customized console particularly and exclusively suited for the present technology. Those skilled in the art will appreciate that the flow charts illustrate the structures of elements and/or module, any of which may be implemented as logic circuits on an integrated circuit or computer program code, that function according to the present technology. As such, the present technology may be practiced by a machine component such as a console that renders the modules and elements in a form that performs a sequence of operations corresponding to those shown in the flow charts by for example, execution by interaction with a customized digital processing apparatus (e.g., specialized console such as shown in FIG. 31 described below).

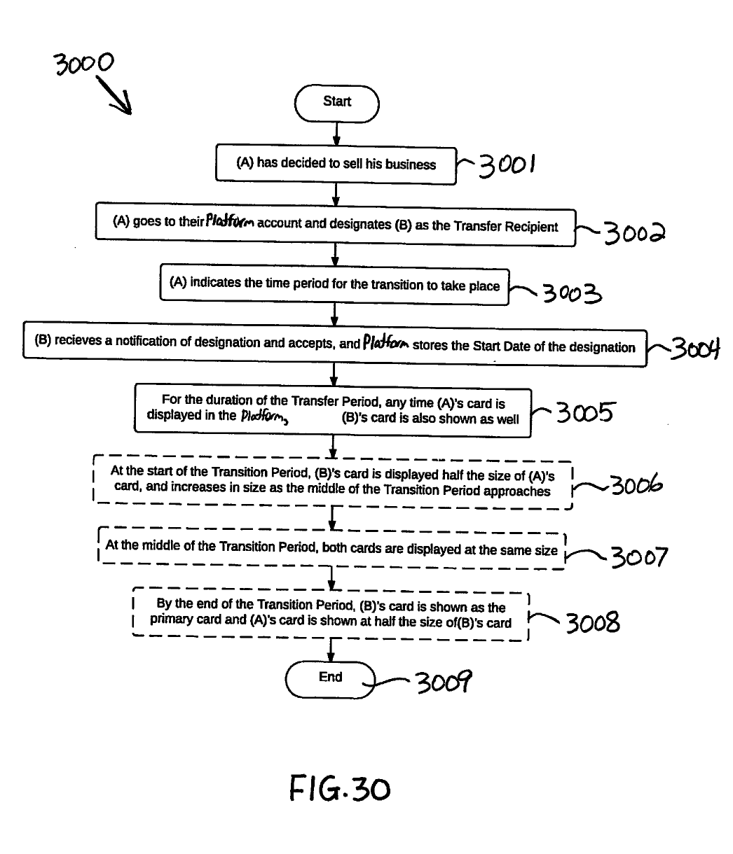

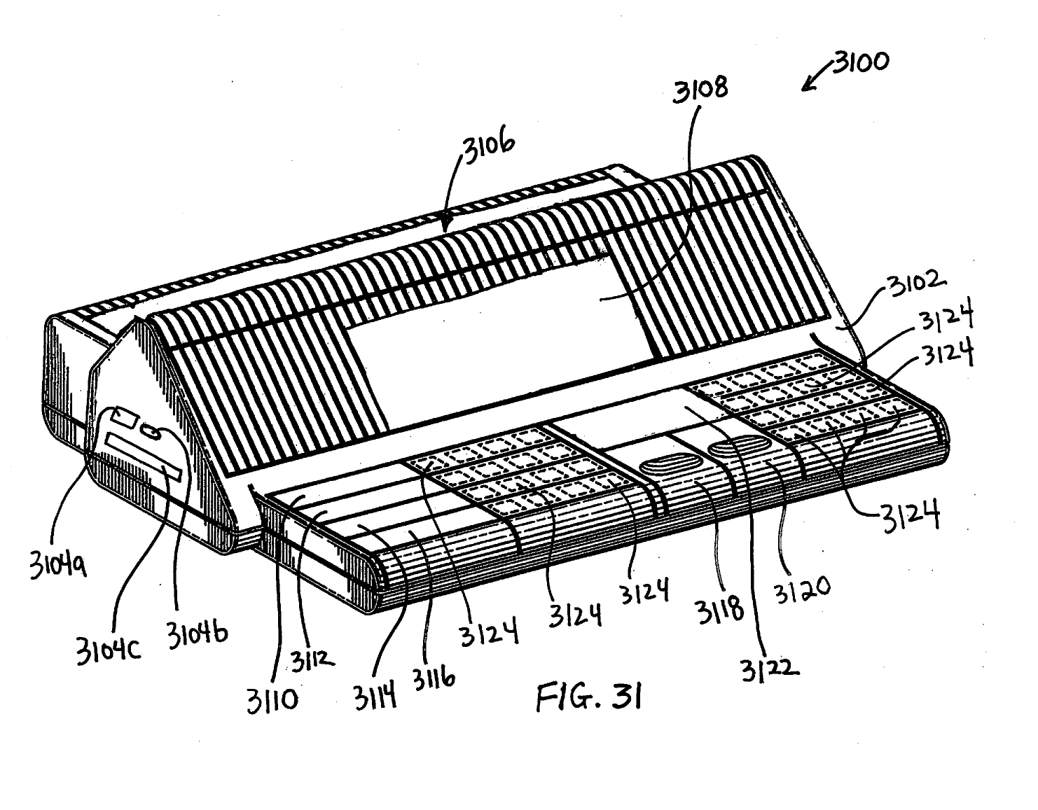

Referring now to FIG. 30, there is illustrated a flowchart 3000 depicting a process for transitioning existing business contacts to new business ownership in accordance with an embodiment of the present technology. The process involves the following steps being performed by two parties: The Business Owner (A) and the Transfer Recipient (B). In a first step 3001, Business Owner (A) has decided to sell her business. In a second step 3002, Business Owner (A) goes to their Platform account and designates the second party as Transfer Recipient (B). In a third step 3003, Business Owner (A) indicates the time period for the transition to take place. In a fourth step 3004, Transfer Recipient (B) receives a notification of designation and accepts, and Platform stores the Start Date of the designation. In a fifth step 3005, for the duration of the Transfer Period, any time Business Owner (A)'s card is displayed in the Platform, Transfer Recipient (B)'s card is also shown as well. In a sixth step 3006, at the start of the Transition Period, Transfer Recipient (B)'s card is displayed as approximately half the size of Business Owner (A)'s card, and increases in size as the middle of the Transition Period approaches. In a seventh step 3007, at the middle of the Transition Period, both cards are displayed at the same size. In an eighth step 3008, by the end of the Transition Period, Transfer Recipient (B)'s card is shown as the primary card and Business Owner (A)'s card is shown at relatively half the size of Transfer Recipient (B)'s card, then the process ends at step 3009.

Referring now to FIG. 31, a console 3100 in accordance with the subject technology is shown. The console 3100 has an ergonomically designed housing 3102 with an interior containing a plurality of components (not shown) necessary to perform the desired functions. For example, some internal components may be processing devices, memory, logic circuitry, WiFi and/or cellular communication modules, card readers for cards of any type (e.g., credit cards, memory cards, storage cards, business cards etc.), electronic media readers, communication devices, and the like.

The console housing 3102 has a plurality of communication ports 3104-a-c for interfacing with other devices such as by Ethernet cable, hotwire, reading cards (in particular business cards) and the like. The housing 3102 also forms a slot 3106 into which various media may be scanned. Printout such as reports and the like can also be provided via the slot 3106. A display screen 3108 can provide preview of such reports, review of scanned documents, cards and the like, and, of course, any and all screen shots contemplated herein.

In one embodiment, the display screen 3108 is particularly suited so that insertion of a business card into card reader 3104c and depression of a function key 3110, results in scanning of the business card with the resulting image displayed on the display 3108 and the same permanently stored in memory. At such time, said business card image can be designated Business Owner (A)'s card by depressing function key 3112. Similarly, the card reader 3104c and function keys 3114, 3116 can be used to designate an image as Transfer Recipient (B)'s card.

Subsequently, the user can navigate through a menu of screens on the display 3108 to start a process such as the one in flowchart 3000. Screen navigation is fairly intuitive by use of tracking pad 3122, left mouse button 3118 and right mouse button 3120. It is also envisioned that the desired process may be started by depression of a particular key on the display. Such key may be any of the plurality of additional keys 3124 on the console 3100. For clarity, only a portion of the keys 3124 are identified with reference numerals. The selected key may be programmable or hardwired to start the process (or a combination thereof), wherein the console ultimately generates instructions and a dataset for transmission to a server that presents, for example, Web pages in accordance with the process.

Continuing with the example of flowchart 3000, the third step 3003 may be accomplished by prompting the user to select a time period for the transition to take place from a menu or by use of a key 3124. At step 3004, the console 3100 can generate and send the notification of designation to Transfer Recipient (B) while receiving and storing the Start Date of the designation. As the remaining parameters may be standard and preselected, at this point, the console 3100 can complete the process of flowchart 3000.

As would be appreciated by those of ordinary skill in the art, the console 3100 is a special use device that may accomplish one or more particular processes by hardwired logic, programmed instructions or a combination thereof. The console 3100 is particularly useful in that repetitive steps are hardwired to particular function keys so that the desired resulting data file or instruction set is easily and quickly built. By WiFi communication or other input, the console can additionally monitor and execute the full process as part of an environment such as the environment 2800 shown in FIG. 28.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., consoles, console keys, mobile devices, modules, databases, interfaces, computers, servers and the like) shown as distinct for purposes of illustration may be incorporated within other functional elements in a particular implementation, whether it be through completely hardware logic, solely software programming, or combinations thereof.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A method for transitioning existing business contacts of a first business to a second business comprising the steps of:
designating the second business as a recipient of the existing business contacts;
indicating a time period for transiting the existing business contacts to become fully associated with the second business;
determining a start date, initial portion, and final portion of the time period;
during the initial portion of the time period, displaying a second business card of the second business with a first business card of the first business any time the first business card is displayed, wherein the second business card is displayed relatively less prominently than the first business card; and
during the final portion of the time period, displaying the second business card with the first business card any time the first business card is displayed, wherein the first business card is displayed relatively less prominently than the second business card.

2. A method as recited in claim 1, further comprising the steps of:
determining a middle portion of the time period; and
during the middle portion of the time period, displaying the second business card with the first business card any time the first business card would normally be virtually displayed, wherein the first and second business cards are displayed equally prominently.

3. A console in a network environment for performing a process, the console comprising:
data storage, a processor, a display, input/output devices, hardwired logic, at least one card reader, and program memory, wherein the processor is in communication with the display, the input/output devices, the data storage, the hardwired logic, the at least one card reader, and the program memory to access data and execute the process, and the at least one card reader is configured to receive a business card and, upon depression of a function key, scan the business card with a resulting image displayed on the display; and
a database on the data storage configured to store and retrieve card data extracted from a plurality of images resulting from scanning business cards in the at least one card reader, the console having logic operative to cause the processor and memory to create, read, update and delete contact information in the data storage, and the user can classify the plurality of resulting images.

4. The console as recited in claim 3, wherein the process is transitioning existing business contacts stored for a first business to a second business, the process including the following steps performed using the console:
entering a time for a transition to start and a time period for the transition to take place;
determining a change point in the time period;
instructing a Web server to provide a first business card associated with the first business in unison with a second business card of the second business on a Web site of the first business, wherein the first business card is relatively larger and more prominent than the second business card before the change point; and
after the change point and until the time period ends, instructing the Web server to provide the first business card in unison with the second business card, wherein the second business card is relatively larger and more prominent than the first business card.

5. The console as recited in claim 4, wherein the process is transitioning existing business contacts stored for a first business to a second business, the process including the following steps performed using the console:
determine a middle period in the time period; and
during the middle period, instructing the Web server to provide the first business card in unison with the second business card, wherein the first and second business cards are approximately similar in size.
